(19) United States
(12) Patent Application Publication
(10) Pub. No.: US 2007/0176116 A1
(43) Pub. Date: Aug. 2, 2007

(54) Self-shielded sterilization apparatus using electron beam irradiation

(76) Inventors: Haifeng Hu, Beijing (CN); Zhiqiang Chen, Beijing (CN); Junli Li, Beijing (CN); Chuanxiang Tang, Beijing (CN); Jianping Cheng, Shuangqinglu (CN); Shenjin Ming, Beijing (CN); Bing Wang, Beijing (CN); Yanfeng Cao, Beijing (CN)

Correspondence Address: SCHWEGMAN, LUNDBERG, WOESSNER & KLUTH, P.A., P.O. BOX 2938, MINNEAPOLIS, MN, 55402, US

(21) Appl. No.: 11/491,773

(22) Filed: Jul. 24, 2006

(30) Foreign Application Priority Data
Jul. 29, 2005 (CN) 2005100834964

(51) Int. Cl. G01N 21/00

(52) U.S. Cl. 250/453.11

(57) ABSTRACT

A self-shielded sterilization apparatus using an electron beam, comprising: an electron beam irradiator for irradiating an electron beam; a shielding for shielding the electron beam irradiated from the electron beam irradiator and a bremsstrahlung of the electron beam; a tray disposed within the shielding for placing thereon an object to be irradiated; an opening for placing an object into and taking the object out of the shielding; and a shielding door for closing the opening. With the above configurations, the apparatus avoids the shield construction taking a large area and the complicated transporting device, which facilitates a miniaturization of the apparatus.

### RELATED APPLICATION

This application claims priority under 35 U.S.C. 119 from Chinese Application No. 200510083496.4 filed 29 Jul. 2005, which application is incorporated herein by reference.

### BACKGROUND OF THE INVENTION

1. Field of the Invention

The present invention relates to a self-shielded sterilization apparatus using electron beam irradiation.

2. Description of the Related Art

The radiation sterilization technology with an electron beam is a processing technology. An object is subject to exposure to an electron beam and a bremsstrahlung of the electron beam and then undergoes biological and physical effects, so as to sterilize the object or change physical properties of the object. It is an important technology for security and antiterrorism when applied to sterilize mails and small objects by means of the electron beam generated by an electron accelerator. An existing apparatus for sterilizing the mails and the small objects is shown in FIG. 1. An electron beam (β-rays) with predetermined energy which is generated by an electron accelerator performs a laterally scanning movement (in a direction perpendicular to a direction in which a scanned object is transported) under an alternative electric field or magnetic field. The scanned object is transported under the electron beam by a transporting device so as to perform a longitudinal movement (in a direction which the scanned object is transported). A scanning speed of the electron beam and a transporting speed of the scanned object are controlled respectively to ensure that a total dose of the rays, which is absorbed in each portion of the scanned object, reaches what is required for sterilizing the object, so as to achieve sterilizing the object. However, in this existing apparatus, a shielding construction is necessarily formed, and the complicated transporting device is used, so that it is difficult to achieve miniaturization of the apparatus. Furthermore, a shielding wall of the shielding construction is perforated therein with openings through which the transporting device passes, which destroys the integrality of the shielding construction and increases the difficulty of radiation protection, thus the apparatus is complicated and costly.

### SUMMARY OF THE INVENTION

The present application is made in view of the above problems of the prior art. It is an object of the present invention to provide a self-shielded sterilization apparatus using an electron beam, which avoids the shielded construction occupying a large area and the complicated transporting device in the prior art apparatus, so that the apparatus according to the present application is miniaturized. As a result, the apparatus according to the present application is simple in structure and inexpensive in cost. In addition, a self-shielded structure of the apparatus according to the present application improves the radiation safety performance.

In accordance with one aspect of the present invention, a self-shielded sterilization apparatus using an electron beam comprises: an electron beam irradiator (an accelerator) including an electron gun for emitting the electron beam, an electron accelerator tube for accelerating the electron beam to a predetermined energy, a drift tube for deflecting the electron beam, and a titanium window for ensuring a vacuum in the electron accelerator tube, an integral shielding; a cooling system including a circulating coolant, pipes, a radiator, and a pump, and a controller for controlling the self-shielded sterilization apparatus to operate in accordance with a preset process. The electron beam irradiator is installed at the center of a top of the integral shielding, a windtight shielding door for placing an object into and taking the object out of the integral shielding is provided in a side wall of the integral shielding, and a tray for supporting the object is disposed in the integral shielding. The tray is supported by a supporting rod connected to a bottom thereof, while the supporting rod projects fluid-tightly through a bottom wall to an outside of the integral shielding, so that the supporting rod is connected with a driving device. The circulating coolant is disposed at a bottom portion inside the integral shielding, and is driven by the pump to flow through the pipes and the radiator, so as to perform a cooling function. The controller controls equipments such as the accelerator, the motor, the cooling system and the shielding door to cooperate in accordance with a preset operating process.

In the above self-shielded sterilization apparatus, the driving device may comprises two meshed bevel gears driven by a motor, or a worm wheel and a worm which are meshed with each other and of which the worm is driven by a motor, or the supporting rod may be connected directly with and driven by a synchronous motor.

In accordance with another aspect of the present invention, a self-shielded sterilization apparatus using an electron beam comprises: an electron beam irradiator (an accelerator) including an electron gun for emitting an electron beam, an electron accelerator tube for accelerating the electron beam to a predetermined energy, a drift tube for deflecting the electron beam, and a titanium window for ensuring a vacuum in the electron accelerator tube, an integral shielding; a cooling system including a circulating coolant, pipes, a radiator, and a pump, and a controller for controlling the self-shielded sterilization apparatus to operate in accordance with a preset process. The electron beam irradiator is installed at the center of a top of the integral shielding, a windtight shielding door for placing an object into and taking the object out of the integral shielding is provided in a side wall of the integral shielding, and a tray for supporting the object is disposed in the integral shielding. The tray is supported by a supporting rod connected to a bottom thereof, while the supporting rod is fixed on a center of a bottom of the integral shielding. The circulating coolant is disposed at a bottom portion inside the integral shielding, and is driven by the pump to flow through the pipes and the radiator, so as to perform a cooling function. The controller controls equipments such as the accelerator, the cooling system and the shielding door to cooperate in accordance with a preset operating process.

With the above configurations, the apparatus according to the present application avoids the shielding construction occupying a large area and the complicated transporting device in the prior art apparatus, which facilitates and miniaturizes the apparatus. As a result, the apparatus according to the present application is simple in structure and inexpensive in cost. In addition, a self-shielded structure of the apparatus according to the present application improves the radiation safety performance. Furthermore, the apparatus according to the present application can be mounted on a vehicle or a mobile dolly to form a mobile apparatus, so as to provide sterilizing processing conveniently.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view showing an existing apparatus for sterilizing mails and small objects.

FIG. 2 is a schematic view showing a self-shielded sterilization apparatus according to an embodiment of the present invention.

FIG. 3 is a schematic view showing a self-shielded sterilization apparatus according to another embodiment of the present invention.

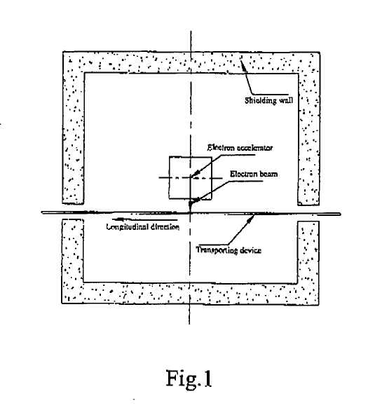

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. However, the present application is not limited to the embodiments.

### Example 1

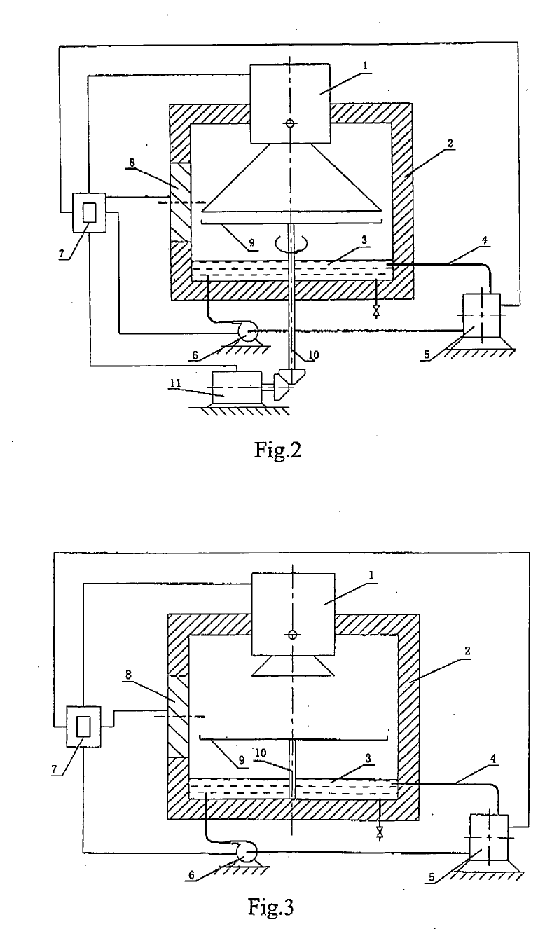

Referring to FIG. 2, a self-shielded sterilization apparatus using an electron beam according to the present invention comprises: an electron beam irradiator (an accelerator) 1 including an electron gun, an electron accelerator tube, a drift tube, and a titanium window; an integral shielding 2; a cooling system including a circulating coolant 3, pipes 4, a radiator 5, and a pump 6; and a controller 7 for controlling the self-shielded sterilization apparatus to operate in accordance with a predetermined process. The electron beam irradiator 1 is installed at the center of a top of the integral shielding 2, a windtight shielding door 8 for placing an object into and taking the object out of the integral shielding 2 is provided in a side wall of the integral shielding 2, and a tray 9 for supporting the object is disposed in the integral shielding 2. The tray 9 is supported by a supporting rod 10 connected to a bottom thereof, while the supporting rod 10 projects fluid-tightly through a bottom wall of the integral shielding 2 to an outside of the integral shielding 2 (For example, the supporting rod 10 extends through an opening formed in the bottom of the integral shielding 2 to the outside, and a gap formed between the supporting rod and the opening is sealed, for example, by a sealing means), so that the supporting rod is connected with a driving device 11. The driving device 11 may be two meshed bevel gears driven by a motor. The circulating coolant 3 is disposed at a bottom portion inside the integral shielding 2, and is driven by the pump 6 to flow through the pipes 4 and the radiator 5, so as to perform a cooling function. Alternatively, the driving device 11 may be a worm wheel and a worm which are meshed with each other and of which the worm is driven by a motor, or the supporting rod 10 may be connected directly with and driven by a synchronous motor, instead of the above driving device.

When an object is scanned by the apparatus configured as above, the controller 7 outputs a control signal with which the shielding door 8 is locked. Then, the controller 7 controls the driving device 11 so that the driving device 11 drives and rotates the tray 9 while the electron beam irradiator (accelerator) 1 is controlled to emit an electron beam and to perform a lateral scanning, so as to scan and sterilize the object placed on the tray 9. During the operation of the apparatus, the pump 6 is controlled to operate, so that the coolant 3 circulates to achieve a cooling function. After the above scanning process is completed, the controller 7 output a signal, with which the electron beam irradiator (accelerator) 1 is controlled to stop emitting the electron beam, and the driving device 11 and thus a rotation of the tray 9 are stopped. After that, the shielding door 8 is unlocked.

In this example, a structure in which a lead layer is coated on both sides thereof with steel layers is used to form the integral shielding 2 and has a shielding thickness equivalent to that of a lead layer with a thickness of 10-15 cm. In addition, the shielding thickness at different portions of the integral shielding 2 may be different. The circulating coolant 3 may be water and may be antifreeze when the apparatus is used in a freezing environment. The electron beam irradiator (accelerator) 1 operates at an emitting frequency of 250 pps, a scanning frequency at which the electron beam scans laterally may be 5 Hz, and the scanning or scanning movement of the electron beam is limited within a scope of a radius of the tray 9. The tray 9 rotates at a rotation speed of 0.5 rpm, and a scanning time required for sterilizing one object is about 2 minutes. Alternatively, the scanning or scanning movement of the electron beam may be limited within a scope of a diameter of the tray 9, and accordingly the emitting frequency at which the electron beam is emitted, the scanning frequency, the rotation speed, and the like may be re-determined according to an actual requirement.

A method for sterilizing an object by using the apparatus according to the above example comprises the following steps:

1. The apparatus is energized; the controller 7 is operated so that the electron beam irradiator (accelerator) 1 is preheated.

2. The shielding door 8 is opened, and then an object to be scanned is placed onto the tray 9 within the integral shielding 2.

3. The shielding door is closed, and next the controller 7 is operated so that the shielding door 8 is locked. After that, the tray 9 is rotated at a rotating speed of 0.5 rpm. The controller 7 is operated so that the electron beam irradiator (accelerator) 1 emits an electron beam and the electron beam performs a laterally scanning movement (in a direction perpendicular to a direction in which the scanned object is moved or rotated) at a scanning frequency of 5 Hz under an alternative electric field or magnetic field.

4. After the scanning and sterilizing of the object are completed, the controller 7 outputs a signal with which the electron beam irradiator (accelerator) 1 is controlled to stop emitting the electron beam, and the driving device 11 and the tray 9 are stopped. After that, the shielding door 8 is unlocked.

5. The shielding door 8 is opened, and the scanned object is taken out of the integral shielding 2.

6. The steps 2-5 are repeated.

### Example 2

Referring to FIG. 3, a self-shielded sterilization apparatus using an electron beam according to the present invention comprises: an electron beam irradiator (an accelerator) 1 including an electron gun, an electron accelerator tube, a drift tube, and a titanium window; an integral shielding 2; a cooling system including a circulating coolant 3, pipes 4, a radiator 5, and a pump 6; and a controller 7 for controlling the self-shielded sterilization apparatus to operate in accordance with a predetermined process. The electron beam irradiator 1 is installed at the center of a top of the integral shielding 2, a windtight shielding door 8 for placing an object into and taking the object out of the integral shielding 2 is provided in a side wall of the integral shielding 2, and a tray 9 for supporting the object is disposed in the integral shielding 2. The tray 9 is supported by a supporting rod 10 connected to a bottom thereof, while the supporting rod 10 fixed to a bottom wall of the integral shielding 2. The circulating coolant 3 is disposed at a bottom portion inside the integral shielding 2, and is driven by the pump 6 to flow through the pipes 4 and the radiator 5, so as to perform a cooling function.

When an object is scanned by the apparatus configured as above, the controller 7 outputs a control signal with which the shielding door 8 is locked. Then, the controller 7 controls the electron beam irradiator (accelerator) 1 to emit an electron beam and to perform a lateral scanning and a longitudinal stepping movement under a magnetic field, so as to scan and sterilize the object placed on the tray 9. During the operation of the apparatus, the pump 6 is controlled to operate, so that the coolant 3 circulates to achieve a cooling function. After the above scanning process is completed, the controller 7 outputs a signal, with which the electron beam irradiator (accelerator) 1 is controlled to stop emitting the electron beam. After that, the shielding door 8 is unlocked.

In this example, a structure in which a lead layer is coated on both sides thereof with steel layers is used to form the integral shielding 2 and has a shielding thickness equivalent to that of a lead layer with a thickness of 10-15 cm. In addition, the shielding thickness at different portions of the integral shielding 2 may be different. The circulating coolant 3 may be water and may be antifreeze when the apparatus is used in a freezing environment. The electron beam irradiator (accelerator) 1 operates at an emitting frequency of 250 pps, a scanning frequency at which the electron beam scans laterally may be 6 Hz, a stepping frequency at which the electron beam steps longitudinally is 12 Hz, the stepping movement of the electron beam is performed when a lateral scanning direction of the electron beam is reversed with a step size of 1 cm, and a scanning time required for sterilizing one object is about 3 seconds. However, the present application is not limited to the above parameters. For example, the emitting frequency at which the electron beam is emitted, the scanning frequency, the step size, and the like may be re-determined according to an actual requirement.

A method for sterilizing an object by using the apparatus according to the above example comprises the following steps:

1. The apparatus is energized; the controller 7 is operated so that the electron beam irradiator (accelerator) 1 is preheated.

2. The shielding door 8 is opened, and then an object to be scanned is placed onto the tray 9 within the integral shielding 2.

3. The shielding door is closed, and next the controller 7 is operated so that the shielding door 8 is locked. After that, the controller 7 is operated, so that the electron beam irradiator (accelerator) 1 emits an electron beam and the electron beam performs a laterally scanning movement at a frequency of 6 Hz and a longitudinally stepping movement at a frequency of 12 Hz under an alternative electric field or magnetic field.

4. After the scanning and sterilizing of the object are completed, the controller 7 outputs a signal with which the electron beam irradiator (accelerator) 1 is controlled to stop emitting the electron beam. After that, the shielding door 8 is unlocked.

5. The shielding door 8 is opened, and the scanned object is taken out of the integral shielding 2.

6. The steps 2-5 are repeated.

Although a few embodiments of the present invention have been shown and described, it would be appreciated by those skilled in the art that changes may be made in these embodiments without departing from the principles and spirit of the invention, the scope of which is defined in the claims and their equivalents.

All documents, patents, and other references listed above are hereby incorporated by reference for any purpose.

What is claimed is:

1. A self-shielded sterilization apparatus using an electron beam irradiation, comprising:
an electron beam irradiator for irradiating an electron beam;
a shielding for shielding the electron beam irradiated from the electron beam irradiator and a bremsstrahlung of the electron beam;
a tray disposed within the shielding for placing thereon an object to be irradiated;
an opening for placing an object into and taking the object out of the shielding; and
a shielding door for closing the opening.

2. The apparatus according to claim 1, wherein
the tray is rotated when the apparatus is in use, so that the irradiated object placed on the tray is scanned by the electron beams.

3. The apparatus according to claim 2, further comprising:
a supporting rod which supports and is fixed to the tray, wherein the supporting rod passes through a bottom wall of the shielding, and the tray is driven and rotated by a driving device disposed outside the shielding.

4. The apparatus according to claim 1, wherein the electron beam irradiator emits electron beam, and the electron beam performs a lateral scanning and a stepping movement, so that the irradiated object placed on the tray is scanned by the electron beams.

5. The apparatus according to claim 1, wherein the apparatus is cooled by a cooling system.

6. The apparatus according to claim 5, wherein the cooling system comprises a radiator disposed outside the shielding, a heat exchanger arranged in the shielding, a pump disposed outside the shielding, and pipes connecting the radiator, the heat exchanger and the pump to constitute a circulating system.

7. The apparatus according to claim 5, wherein the cooling system comprises a radiator disposed outside the shielding, a coolant contained in a bottom portion within the shielding, a pump disposed outside the shielding, and pipes connecting the radiator, the bottom within the shielding, and the pump to constitute a circulating system.

8. The apparatus according to claim 1, further comprising:
a supporting rod which fixes and supported the tray on a bottom wall of the shielding.

9. The apparatus according to claim 1, wherein the shielding is integral.
